(19) United States
(12) Patent Application Publication
(10) Pub. No.: US 2009/0198540 A1
(43) Pub. Date: Aug. 6, 2009

(54) METHOD AND SYSTEM FOR DETERMINING AN EXECUTION SEQUENCE OF A SET OF SALES ORDERS

(76) Inventors: STEFAN KIENZLE, St.Leon-Rot (DE); Reiner Seiz, Gemmrigheim (DE)

Correspondence Address: SAP AG, 3410 HILLVIEW AVENUE, PALO ALTO, CA, 94304, US

(21) Appl. No.: 12/212,656

(22) Filed: Sep. 18, 2008

Related U.S. Application Data
(60) Provisional application No. 61/025,833, filed on Feb. 4, 2008.

(51) Int. Cl. G06Q 10/00

(52) U.S. Cl. 705/7

(57) ABSTRACT

Disclosed is a method and system for receiving a work order having a set of sales orders and determining sales order parameters such as a due date of a sales order and a restriction on the sales order. The method also includes determining a work station to execute the work order based on the sales order parameters, determining a work load of the work station executing the work order and generating an execution sequence of the set of sales orders based on the work load.

This application claims the benefit of and priority to U.S. Provisional Patent Application No. U.S. 61/025,833, filed Feb. 4, 2008, titled “METHOD AND SYSTEM FOR DETERMINING AN EXECUTION SEQUENCE OF A SET OF SALES ORDERS,” which is incorporated herein by reference in its entirety.

### FIELD OF THE INVENTION

The invention generally relates to the field of supply chain management and specifically to determine an execution sequence of a set of sales order in a work order.

### BACKGROUND OF THE INVENTION

In a supply chain management scenario, a work center receives a work order for manufacturing a product. The work order is typically a set of sales orders. A sales order typically has details for manufacturing a component, parts of a component, and assembling various components into a saleable product. For example, a work order for manufacturing a car may contain a set of sales orders. The set of sales orders may include a first sales order for manufacturing chassis, a second sales order for manufacturing the dashboard, a third sales order for manufacturing tires and so on. The set of sales orders is typically executed on a work station in the work center. The set of sales orders may be processed by a number of different work stations to produce a product that may be sold to a customer.

Since the work station may execute a number of sales orders, it may be necessary to plan a sequence in which the set of sales orders is executed in the work station. Planning the sequence of execution of the set of sales orders typically enables the work station to be utilized optimally otherwise the work station may be underutilized or over utilized. Existing solutions for determining the sequence of execution of the set of sales order, typically do not consider parameters such as a work load of the work station. In such cases, the work station may end up being underutilized or over utilized and may affect the delivery time of the product manufactured.

### SUMMARY OF THE INVENTION

What is described is a method and system for receiving a work order having a set of sales orders and determining sales order parameters such as a due date of a sales order and a restriction on the sales order. The method also includes determining a work station to execute the work order based on the sales order parameters, determining a work load of the work station executing the work order and generating an execution sequence of the set of sales orders based on the work load.

### BRIEF DESCRIPTION OF THE DRAWINGS

FIG. 1 is a flow diagram for generating an execution sequence of a set of sales orders according to an embodiment of the invention.

FIG. 2 is a flow diagram for determining a work load of a work station executing a work order according to an embodiment of the invention.

FIG. 3 is a table for an execution sequence of an exemplary set of sales orders in the work order according to an embodiment of the invention.

FIG. 4 is a diagram for generating an execution sequence of the set of sales orders according to an embodiment of the invention.

FIG. 5 is a block diagram of various components of a system for generating an execution sequence of the set of sales order according to an embodiment of the invention.

### DETAILED DESCRIPTION

What is described is a method and system for receiving a work order having a set of sales orders and determining sales order parameters such as a due date of a sales order and a restriction on the sales order. The method also includes determining a work station to execute the work order based on the sales order parameters, determining a work load of the work station executing the work order and generating an execution sequence of the set of sales orders based on the work load.

In an embodiment, a work order has a set of sales orders. A sales order typically has details for manufacturing a component, assembling various materials into one product. The work order typically is executed on a work station meant for a specific purpose such as manufacturing tires of a car. The work order may be processed by a number of different work stations to produce a finished product that may be sold to a customer.

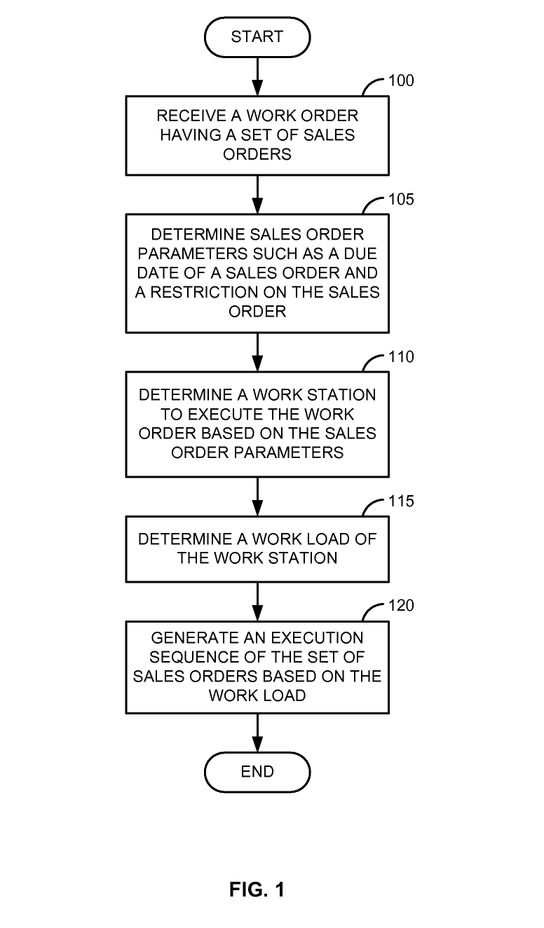

FIG. 1 is a flow diagram for generating an execution sequence of a set of sales orders according to an embodiment of the invention. At step 100, a work order having a set of sales orders is received. At step 105, sales order parameters of the set of sales orders are determined. The sales order parameters determined include a due date of a sales order, and a restriction on the sales order. The due date specifies a date and time by which the sales order has to be completely processed. In an embodiment, the sales order contains a start date and time which specifies a date and time at which the processing of the sales order starts. The restriction specifies a limitation on the sales order. In an embodiment the restriction specifies a time of the day at which the sales order may be executed.

At step 110, a work station to execute the sales order is determined based on the sales order parameters. At step 115, a work load of the work station executing the sales order is determined. At step 120, an execution sequence of the set of sales orders is generated based on the work load of the work station. The execution sequence specifies a sequence in which the set of sales orders are executed by the work station.

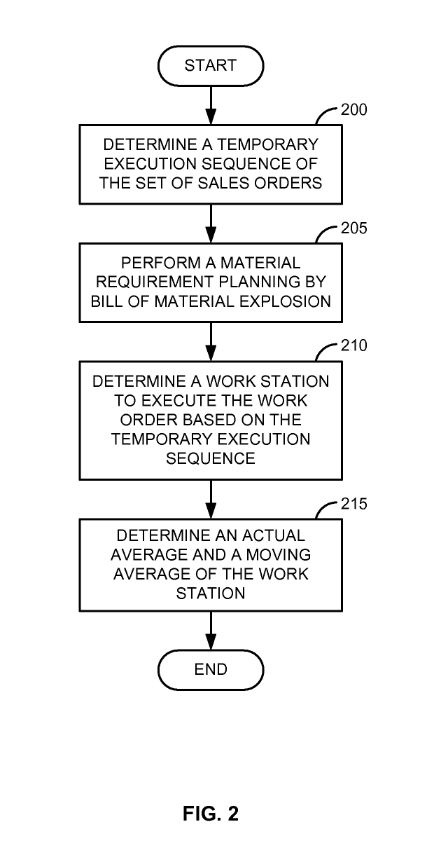

FIG. 2 is a flow diagram for determining a work load of a work station executing a work order according to an embodiment of the invention. At step 200, a temporary execution sequence of the set of sales orders is determined based on the sales order parameters such as the due date of the sales order and the restriction on the sales order. At step 205, a material requirement planning is performed for the set of sales orders in the work order. The material requirement planning is performed by a bill of material explosion. In an embodiment, the material requirement planning is intended to plan manufacturing activities, delivery schedules and purchasing activities.

A bill of material is a parts list of components needed to complete a saleable product. A bill of material explosion determines all the components that are there in the sales order, determines the materials required to manufacture the components and the cost involved in manufacturing the components. After the materials are determined, at step 210, a work station is assigned to execute the work order based on the temporary execution sequence. At step 215, work load parameters such as an actual average of the work station and a moving average of the work station are determined. An actual task time is the time taken for executing a sales order by a work station. An actual average is an average of the actual task time of the sales order executed by a number of work stations. A moving average is an average of actual averages of three consecutive sales orders executed in the work station.

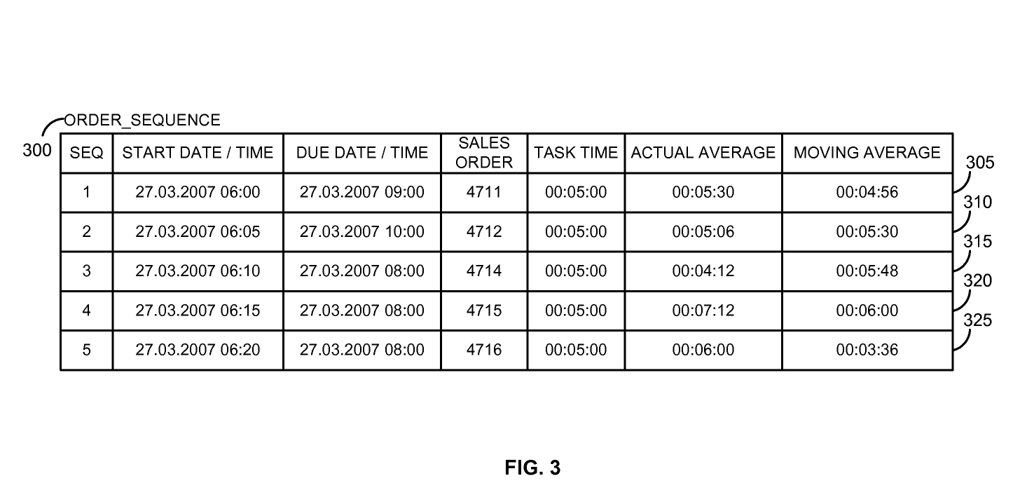

FIG. 3 is a table for an execution sequence of an exemplary set of sales orders in the work order according to an embodiment of the invention. Table order_sequence 300 depicts an execution sequence of the set of sales orders executed in a work station. The work order has sales orders such as “sales order 4711” as depicted in first row 305, “sales order 4712” as depicted in second row 310, “sales order 4714” as depicted in third row 315, “sales order 4715” as depicted in fourth row 320, and “sales order 4716” as depicted in fifth row 325. The work station executes the set of sales orders in the following sequence: “sales order 4711”, “sales order 4712”, “sales order 4714”, “sales order 4715”, and “sales order 4716” as depicted in the table order_sequence 300.

“Sales order 4711” is first in the execution sequence as depicted in first row 305. “Sales order 4711” has a “start date/time” of “27.03.2007 06:00” which means that processing of “sales order 4711” has to start by “27.03.2007 06:00”. “Sales order 4711” has a “due date/time” of “27.03.2007 09:00” which means that the “sales order 4711” has to be processed by “27.03.2007 09:00”. In first row 305, “sales order 4711” has “task time” of “00:05:00” which means a planned execution duration of “sales order 4711” is five minutes. In first row 305, “sales order 4711” has “actual average” of “00:05:30” and a “moving average” of “00:04:56”. An actual task time is the time taken for executing the sales order by the work station. An actual average is an average of the actual task time of “sales order 4711” executed by a number of work stations. A moving average is an average of three consecutive actual averages in the table order_sequence 300. In first row 305, “actual average” of “00:05:30” implies that “sales order 4711” consumes five minutes and thirty six seconds to execute per work station. In first row 305, “moving average” of “00:04:56” implies that “sales order 4711” consumes four minutes and fifty six seconds on the work station in an execution cycle of three consecutive sales orders such as “sales order 4711”, “sales order 4712” and “sales order 4714”.

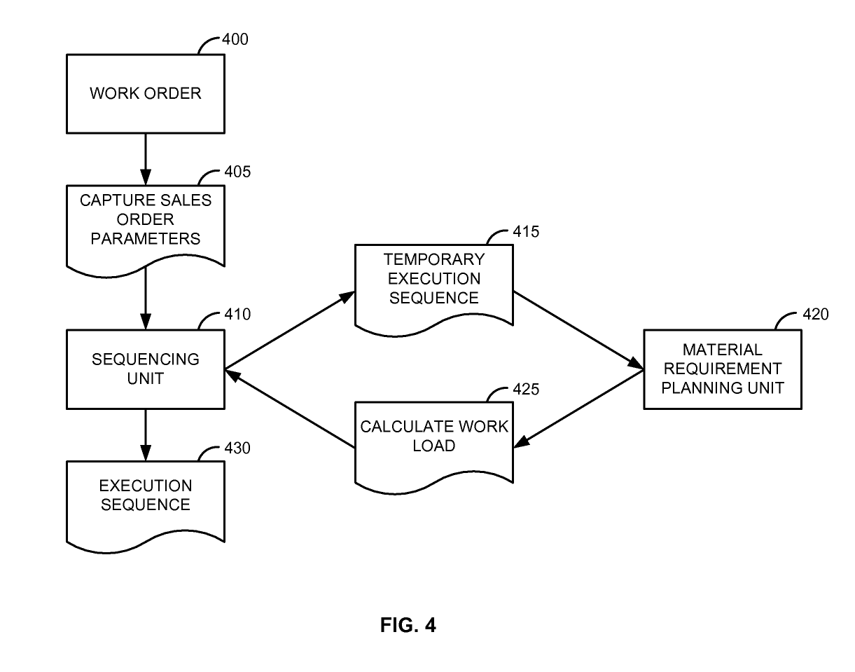

FIG. 4 is a diagram for generating an execution sequence of the set of sales orders according to an embodiment of the invention. Work order 400 contains a set of sales orders. The set of sales orders include “sales order 4711”, “sales order 4712”, “sales order 4714”, “sales order 4715”, and “sales order 4716” as depicted in table order_sequence 300 (as shown in FIG. 3). In an embodiment, work order 400 may be a work order for manufacturing a car. The set of sales orders may be sales orders for manufacturing an engine, assembling a body chassis, manufacturing the paint, and fixing wheels.

At process block 405, sales order parameters are captured. The sales order parameters include a due date of a sales order, and a restriction on the sales order. In an embodiment, the restriction on the sales order may include restrictions such as a quantity restriction, an M of N restriction, a position restriction, a distance restriction, a block restriction, and an equal distribution restriction. The quantity restriction is a restriction on a quantity of a material that may be processed, for example, a minimum of 100 pieces have to be manufactured. An example of M of N restriction may include a restriction such as out of 5 cars manufactured, 2 must be convertible cars. An example of position restriction may include a restriction such as one car from a pilot series should be in the 5^{th} position. An example of distance restriction may include a restriction such as between 3 cars, there must be 1 auto transmission car. An example of equal distribution may include a restriction such as the right hand drive cars equally distributed over 100 cars.

Sequencing unit 410 receives work order 400 and the sales order parameters as input. Sequencing unit 410 determines a temporary execution sequence 415 of the set of sales orders based on the sales order parameters. Sequencing unit 410 uses a general sequencing algorithm that determines a sequence of activities based on defined parameters. In an embodiment, sequencing unit 410 uses a genetic algorithm provided by SAP AG. The objective of the genetic algorithm is to bring out a robust solution for multi criteria optimization, select a solution out of solutions with similar overall quality and different components. The genetic algorithm works based on the concept of evolution. The genetic algorithm determines possible candidate solutions by crossover or recombination of activities and by mutation. Typical mutations include exchanging sequence of activities. A better candidate is chosen as a parent and its child solutions determined by mutations are evaluated. Finally, a better sequence is chosen by eliminating the worse ones.

Material requirement planning unit 420 receives temporary execution sequence 415 as input and determines a work load of the work station executing work order 400. The material requirement planning is a production planning and an inventory control system used to manage a manufacturing process. In an embodiment, the material requirement planning is intended to meet the following objectives among others:
Ensure materials and products are available for production and delivery to customers.
Maintain a lowest possible level of inventory.
Plan manufacturing activities, delivery schedules and purchasing activities.

The material requirement planning is performed by a bill of material explosion. A bill of material is a parts list of components needed to complete a saleable product. The bill of material is a complete, formally structured list of the components that make up a product or assembly. The list contains an object number of each component, together with the quantity and unit of measure. For example, the bill of material for the saleable product such as a personal computer would list the computer, its major sub-assemblies such as a mother board, a chassis, a modem, a keyboard, a display as well as additional materials needed such as shipping box, a user manual, packaging, and packaging labels. A bill of material explosion is a process used to determine material requirements for a product in a sales order, look at the overall structure of the product in a design department, see an overview of the parts and materials required for the product, and calculate the effects of changes to costs. The bill of material explosion is performed for the set of sales orders. After the material and parts are determined, a work station is assigned to the set of sales orders. In an embodiment, the work order may be executed on a number of different work stations to produce the saleable product.

A work load 425 of the work station executing the set of sales order is determined. Determining work load 425 includes determining an actual average of the sales order and a moving average of the sales order. Work load 425 is input to sequencing unit 410 along with the set of sales orders. Sequencing unit 410 considers work load 425 along with the sales order parameters to determine execution sequence 430 of the set of sales orders. Execution sequence 430 is depicted in the table order_sequence 300. The actual average and the moving average are generated in execution sequence 430. Execution sequence 430 with a moving average value lesser than or equal to a task time is an optimal sequence of execution. The objective of sequencing unit 410 is to generate execution sequence 430 that has the moving average value lesser than or equal to the task time of the sales order. The moving average value is determined for a set of three consecutive sales orders. In an embodiment, the moving average may be determined for any number of sales orders. The moving average is an average of actual averages of three consecutive sales orders executed in the work station. The moving average with the value lesser than or equal to the task time means that a sales order to execute in a work station executing three consecutive sales orders consumes a time lesser or equal to the task time of the sales order.

Execution sequence 430 is more optimal than temporary execution sequence 415 since temporary execution sequence 415 does not consider work load 425 of the work station for determining a sequence of execution of the set of sales orders. If the work load is not considered to determine the sequence of execution of the set of sales orders, then the work station may be underutilized or over utilized. This typically may affect a planned delivery time of the product.

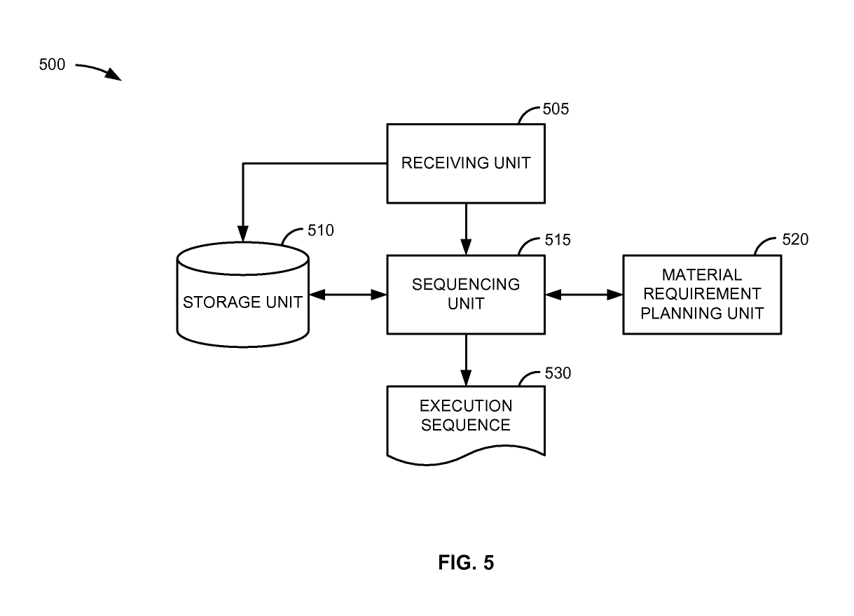

FIG. 5 is a block diagram of various components of a system for generating an execution sequence of the set of sales order according to an embodiment of the invention. System 500 includes receiving unit 505 to receive a work order. The work order has a set of sales orders. Receiving unit 505 determines sales order parameters such as a due date of a sales order and a restriction on the sales order and stores the sales order parameters in storage unit 510. In an embodiment, storage unit 510 could be a database, file and a memory unit. Sequencing unit 515 receives the set of sales orders from receiving unit 505 and obtains the sales order parameters such as the restriction on the sales order from storage unit 510. Sequencing unit 515 determines a temporary execution sequence of the set of sales orders based on the sales order parameters. Material requirement planning unit 520 assigns a work station to the set of sales orders and determines a work load of the work station based on the temporary execution sequence. Sequencing unit 515 receives the work load as the input along with the set of sales orders. Sequencing unit 515 generates execution sequence 530 of the set of sales orders based on the work load.

Embodiments of the invention may include various steps as set forth above. The steps may be embodied in machine-executable program code which causes a general-purpose or special-purpose processor to perform certain steps. Alternatively, these steps may be performed by specific hardware components that contain hardwired logic for performing the steps, or by any combination of programmed computer components and custom hardware components.

Embodiments of the present invention may also be provided as a machine-readable medium for storing the machine-executable instructions. The machine-readable medium may include, but is not limited to, flash memory, optical disks, CD-ROMs, DVD ROMs, RAMs, EPROMs, EEPROMs, magnetic or optical cards, propagation media or any other type of machine-readable media suitable for storing electronic instructions. For example, the present invention may be downloaded as a computer program which may be transferred from a remote computer (e.g., a server) to a requesting computer (e.g., a client) by way of data signals embodied in a carrier wave or other propagation medium via a communication link (e.g., a modem or network connection).

Throughout the foregoing description, for the purposes of explanation, numerous specific details were set forth in order to provide a thorough understanding of the invention. It will be apparent, however, to one skilled in the art that the invention may be practiced without some of these specific details. Accordingly, the scope and spirit of the invention should be judged in terms of the claims which follow.

What is claimed is:

1. A method, comprising:
receiving a work order having a set of sales orders;
determining sales order parameters of the set of sales orders;
determining a work station to execute the work order based on the sales order parameters;
determining a work load of the work station executing the work order; and
generating an execution sequence of the set of sales orders based on the work load.

2. The method in claim 1, wherein a sales order parameter comprises a parameter selected from a group consisting of a due date of a sales order, and a restriction on the sales order.

3. The method in claim 2, wherein a restriction on the sales order comprises a rule selected from a group consisting of a minimum time interval between two sales orders, a maximum number of total sales orders executed per day, a maximum number of times the sales order is executed per day, a type of the sales order executed by a work station, and a time of the day at which the sales order is executed.

4. The method in claim 1, wherein determining a work station to execute the work order comprises determining a temporary execution sequence of the set of sales orders based on the sales order parameters.

5. The method in claim 1, wherein determining a work load of a work station comprises performing a material resource planning by a bill of material explosion to assign the sales order to the work station.

6. The method in claim 1, wherein determining a work load of a work station further comprises determining work load parameters selected from a group consisting of an actual average of the work station and a moving average of the work station.

7. The method in claim 1, further comprising generating a report having the execution sequence, an actual average of the work station and a moving average of the work station.

8. The method in claim 7, further comprising generating the report in a file format that includes an extensible markup language (XML).

9. A system, comprising:
a receiving unit to receive a work order having a set of sales orders;
a material requirement planning unit electronically coupled to the receiving unit to assign a work station to execute the work order and to determine a work load of the work station; and
a sequencing unit electronically coupled to the material requirement planning unit to generate an execution sequence in which the set of sales orders is executed based on the work load.

10. The system in claim 9 further comprising a storage unit electronically coupled to the receiving unit to store sales order parameters.

11. An article of manufacture, comprising:
a machine readable medium having instructions which when executed by a machine cause the machine to:
receive a work order having a set of sales orders;
determine sales order parameters of the set of sales orders;
determine a work station to execute the work order based on the sales order parameters;
determine a work load of the work station executing the work order; and
generate an execution sequence of the set of sales orders based on the work load.

12. The article of manufacture in claim 11, wherein the machine readable medium provides instructions, which when executed by a machine cause the machine to determine a temporary execution sequence of the set of sales orders based on the sales order parameters.

13. The article of manufacture in claim 11, wherein the machine readable medium provides instructions, which when executed by a machine cause the machine to perform a material resource planning by a bill of material explosion to assign the sales order to the work station.

14. The article of manufacture in claim 11, wherein the machine readable medium provides instructions, which when executed by a machine cause the machine to determine an actual average of the work station and a moving average of the work station.

15. The article of manufacture in claim 11, wherein the machine readable medium provides instructions, which when executed by a machine cause the machine to generate a report having the execution sequence and an actual average of the work station and a moving average of the work station.
